(19) United States
(12) Patent Application Publication
(10) Pub. No.: US 2001/0051685 A1
(43) Pub. Date: Dec. 13, 2001

(54) Gel-containing rubber compounds for tire components subjected to dynamic stress

(76) Inventors: Werner Obrecht, Moers (DE); Anthony Sumner, Koln (DE)

Correspondence Address: BAYER CORPORATION, PATENT DEPARTMENT, 100 BAYER ROAD, PITTSBURGH, PA, 15205, US

(21) Appl. No.: 09/841,462

(22) Filed: Apr. 24, 2001

(30) Foreign Application Priority Data
Apr. 28, 2000 (DE) 10021070.8

(51) Int. Cl. C08J 3/00

(52) U.S. Cl. 524/526; 524/525

(57) ABSTRACT

The invention concerns rubber compounds consisting of at least one double bond-containing rubber and additions of polybutadiene rubber particles having a glass transition temperature <−60° C. together with vulcanizates and rubber molding manufactured therefrom.

The rubber compounds according to the invention are characterized in the un-crosslinked state by good processability and adequate scorch resistance and in the vulcanized state by high Shore A hardness, high impact resistance, low hysteresis losses and low heating-up under dynamic stress, together with a low specific density.

The vulcanizates are particularly suitable for the manufacture of tire components for which low heating-up under dynamic stress is required, e.g. for tire bead and apex compounds, subtread compounds, tire carcasses and for tire sidewalls. The compounds are particularly suitable for the manufacture of reinforced sidewalls for tires with emergency running properties (inserts for run-flat tires).

### FIELD OF THE INVENTION

The invention concerns rubber mixes (rubber compounds) that contain rubber particles (rubber gels) made from polybutadiene with a glass transition temperature <−60° C. and are characterized in that the un-crosslinked state has good processability and adequately high scorch resistance and for example, in the vulcanized state display high Shore A hardness, high impact resistance, low hysteresis losses and low heating-up under dynamic stress and whose vulcanizates produced therefrom are light in weight. The vulcanizates are particularly suitable for manufacturing tire components for which low heating-up under dynamic stress is required, e.g., for tire bead and apex compounds, tire carcasses, subtread compounds and especially for tire sidewalls. The compounds are particularly suitable for the manufacture of reinforced sidewalls for tires with emergency running properties (inserts for run-flat tires).

### BACKGROUND OF THE INVENTION

The conventional procedure for producing tire compounds, which meets the list of requirements for tire sidewall reinforcements, requires the manufacturing of rubber compounds containing fillers in amounts >50 phr. The addition of conventional inorganic fillers such as carbon black or silicic acid in quantities >50 parts by weight, relative to 100 parts by weight of rubber, produces compounds with high Shore A hardness, which means that the viscosity of these compounds is very high, as a result of which the compounds are difficult to process. Furthermore, high frictional forces can occur during production of the compound such that the compounds heat up vigorously, and premature scorch, which is detectable from the short scorch times for the compounds, can arise. In the vulcanized state, such rubber articles display low elasticities and a pronounced evolution of heat under dynamic stress. As a consequence of the high densities of the inorganic fillers used (ρ_{carbon black}=1.8 g/cm³; ρ_{silicic acid}=2.1 g/cm³), the rubber articles manufactured from such compounds are heavy.

The compound properties in the case of compounds filled with silicic acid are improved by the addition of sulfur-containing organo-silicon compounds (see DE-A 21 41 159, U.S. Pat. No. 3,873,489, U.S. Pat. No. 5,110,969, U.S. Pat. No. 4,709,065 and U.S. Pat. No. 5,227,425). In these patent publications, the positive influence of sulfur-containing organo-silicon compounds on the mechanical properties of vulcanizates filled with silicic acid is described. However, compound production is complex, the scorch times short and the hysteresis losses that occur under dynamic stresses as well as the associated evolution of heat in such vulcanizates require further improvement.

The use of rubbers having star-shaped branching (EP-A 218 876) in combination with conventional fillers such as carbon black enables rubber compounds to be produced that are suitable for producing vulcanizates with a high Shore A hardness without an excessive rise in the compound viscosity. Such compounds can be readily processed and are less susceptible to scorch. However, the impact resistance of such vulcanizates and the evolution of heat under dynamic stress are still not adequate. Furthermore, the addition of rubbers having star-shaped branching does not reduce the weight of the rubber articles manufactured therefrom.

By using bis-thiocarbamoyl compounds that lead to 1,2-dithioethanediyl bridges in the vulcanizate, tire treads (EP-A 0 432 417) and tire sidewalls (EP-A 0 432 405) can be produced with high impact resistance and low heating-up under dynamic stress (measured using the Goodrich flexometer). However, the reduction in the build-up of heat under dynamic stress is still not adequate.

The complete or partial substitution of microgels for conventional inorganic fillers is described for example in the following patent applications or patents: EP-A 405 216, DE-A 42 20 563, GB-A 1 078 400, EP-A 432 405, EP-A 854 170 and EP-A 432 417. The use of CR, BR, SBR and NBR microgels in compounds with double bond-containing rubbers is described in patents/patent applications EP-A 405 216, EP-A 854 170, U.S. Pat. No. 5 395 891 and GB-A 1 078 400. However, none of these patent publications describes compounds that exhibit a high modulus under low deformation (<300%) and very low hysteresis losses under dynamic stress and a very low evolution of heat.

### SUMMARY OF THE INVENTION

The object was, therefore, to produce rubber compounds that are characterized in the un-crosslinked state by good processability and high scorch resistance and in the vulcanized state by high Shore A hardness, high impact resistance and in particular, low hysteresis losses and low heating-up under dynamic stress together with a light weight.

This object is achieved with rubber compounds having at least one double bond-containing rubber (A) and particles of polybutadiene rubber with a glass transition temperature <−60° C. (B) and optionally other fillers and rubber auxiliary substances.

### DETAILED DESCRIPTION OF THE INVENTION

The present invention therefore provides rubber compounds comprising at least one double bond-containing rubber (A) and particles of polybutadiene rubber with a glass transition temperature <−60° C., preferably −65° C. to −100° C., whereby component (B) is present in quantities of 10 to 150, preferably 30 to 120 wt. % relative to the total amount of component (A), and optionally other fillers and rubber auxiliary substances.

The term double bond-containing rubber (A) refers to rubbers that under DIN/ISO 1629 are designated as R rubbers. These rubbers have a double bond in the main chain. Examples include:

NR: natural rubber

SBR: styrene-butadiene rubber

SIBR: styrene-isoprene-butadiene rubber

BR: polybutadiene rubber in unbranched or branched form, preferably in a form displaying star-shaped branching

NBR: nitrile rubber

HR: butyl rubber

HNBR: partially hydrogenated nitrile rubber

SNBR: styrene-butadiene-acrylonitrile rubber

CR: polychloroprene

However, the term double bond-containing rubbers (A) should also be understood to include rubbers that are designated as M rubbers under DIN/ISO 1629 and exhibit double bonds in side chains in addition to the saturated main chain. These include EPDM, for example.

Preferred rubbers are NR, BR, SBR, SIBR and SNBR.

The term “particles of polybutadiene rubber” refers to rubber gels or microgels. The general production thereof is described in U.S. Pat. No. 5,395,891, for example.

The microgels have particle diameters of 5-1000 nm, preferably 20-600 nm (DVN value according to DIN 53206). By reason of their crosslinking, they are insoluble and are swellable in suitable swelling agents such as toluene, for example. The swelling index of the microgels (Sᵢ) in toluene is 1-50, preferably 6-20. The swelling index is calculated from the weight of the solvent-containing gel (after centrifugation at 20,000 rpm) and the weight of the dry gel:

Sᵢ=wet weight of the gel/dry weight of the gel.

To determine the swelling index, 250 mg gel are swollen in 25 ml toluene for 24 h with shaking. The gel is centrifuged off and weighed and then dried at 70° C. to constant weight and weighed again.

The glass transition temperatures of the polybutadiene particles are determined by means of DSC (differential scanning calorimetry). The un-crosslinked rubber starting products can be produced by known means by emulsion polymerization and solution polymerization.

In the production of polybutadiene rubber particles by emulsion polymerization, additional radically polymerizable monomers can also be used, specifically in quantities of up to 10 wt. %. Examples include styrene, acrylonitrile, isoprene, esters of acrylic and methacrylic acid, tetrafluoro-ethylene, vinylidene fluoride, hexafluoropropene, 2-chlorobutadiene, 2,3-dichlorobutadiene and double bond-containing carboxylic acids such as acrylic acid, methacrylic acid, maleic acid, itaconic acid, double bond-containing hydroxy compounds such as hydroxyethyl methacrylate, hydroxyethyl acrylate, hydroxypropyl methacrylate, hydroxybutyl methacrylate, or double bond-containing epoxies such as glycidyl methacrylate or glycidyl acrylate.

Crosslinking of the rubber particles can be achieved directly during emulsion polymerization by copolymerization with multifunctional compounds having a crosslinking action. Preferred multifunctional comonomers are compounds having at least two, preferably 2 to 4 copolymerizable C═C double bonds, such as diisopropenyl benzene, divinyl benzene, divinyl ether, divinyl sulfone, diallyl phthalate, triallyl cyanurate, triallyl isocyanurate, 1,2-polybutadiene, N,N′-m-phenylene maleimide, 2,4-toluylene bis(maleimide) and/or triallyl trimellitate. Further examples that can be used include the acrylates and methacrylates of polyhydric, preferably dihydric to quadrihydric, C₂ to C₁₀ alcohols, such as ethylene glycol, propane diol-1,2, butane diol, hexane diol, polyethylene glycol having 2 to 20, preferably 2 to 8 oxyethylene units, neopentyl glycol, bisphenol A, glycerol, trimethylol propane, pentaerythritol, sorbitol with unsaturated polyesters consisting of aliphatic di- and polyols and maleic acid, fumaric acid and/or itaconic acid.

The crosslinking of the rubber -particles during emulsion polymerization can also be achieved by continuing polymerization until high conversions are obtained or in the monomer feed process by polymerization with high internal conversions. Another possibility also consists in performing the emulsion polymerization in the absence of regulators.

In order to crosslink the un-crosslinked or weakly crosslinked butadiene (co)polymer following emulsion polymerization, the latices obtained during the emulsion polymerization are preferably used. In principle, this method can also be used with non-aqueous polymer dispersions that are accessible by other means, e.g., by re-solution.

Examples of chemicals having a suitable crosslinking action include organic peroxides such as dicumyl peroxide, t-butyl cumyl peroxide, bis(t-butyl peroxyisopropyl)benzene, di-t-butyl peroxide, 2,5-dimethyl hexane-2,5-dihydroperoxide, 2,5-dimethyl hexine-3,2,5-dihydroperoxide, dibenzoyl peroxide, bis(2,4-dichlorobenzoyl)peroxide, t-butyl perbenzoate, and organic azo compounds such as azo bis-isobutyronitrile and azo bis-cyclohexane nitrile, and dimercapto and polymercapto compounds such as dimercaptoethane, 1,6-dimercaptohexane, 1,3,5-trimercaptotriazine and mercapto-terminated polysulfide rubbers such as mercapto-terminated reaction products of bis-chloroethyl formal with sodium polysulfide. The optimum temperature at which the post-crosslinking is performed naturally depends on the reactivity of the crosslinking agent and it can be performed at temperatures from room temperature to approx. 180° C., optionally under elevated pressure (see Houben-Weyl, Methoden der organischen Chemie, 4th edition, volume 14/2, page 848). More preferred crosslinking agents are peroxides.

The crosslinking of polybutadiene rubbers containing C═C double bonds to form rubber particles can also be performed in dispersion or emulsion with simultaneous partial or complete hydrogenation of the C═C double bond with hydrazine, as described in U.S. Pat. No. 5,302,696 or U.S. Pat. No. 5,442,009, or optionally with other hydrogenation agents, such as organometal hydride complexes, for example.

Polybutadiene rubbers produced by solution polymerization can also be used as starting products for the production of microgels. In these cases solutions of these rubbers in suitable organic solvents are used. The desired sizes of microgels are produced by mixing the rubber solution in a liquid medium, preferably in water, optionally with the addition of suitable surface-active agents such as surfactants, by means of suitable units such that a dispersion of the rubber in the appropriate particle size range is obtained. Crosslinking of the dispersed solution rubbers is performed in the same way as described above for the post-crosslinking of emulsion polymers. The compounds already specified are suitable as crosslinking agents, whereby the solvent used to produce the dispersion can optionally be removed by distillation for example prior to crosslinking.

For the rubber compounds according to the present invention, it is important that polybutadiene rubber particles (gels) are used that have a glass transition temperature of <−60° C., preferably −65° C. to −100° C. Such polybutadiene rubber particles with the specified glass transition temperatures can be selectively manufactured by following the instructions set out above for manufacturing such gels, for example by the selective use of crosslinking agents and by the use of multifunctional dienes during emulsion polymerization of the butadiene.

The rubber compounds according to the present invention comprises at least one double bond-containing rubber (A) with additions of particles of polybutadiene rubber with a glass transition temperature <−60° C. (B) can optionally contain other fillers and rubber auxiliary substances.

Particularly suitable fillers for the production of rubber compounds and vulcanizates according to the present invention are inorganic and polymeric fillers:

carbon blacks. The carbon blacks for use in this case are manufactured by the lampblack, furnace or channel black method and have BET surface areas of 20-200 m²/g, such as: SAF, ISAF, IISAF, HAF, FEF or GPF carbon blacks.

fine-particle silicic acid, produced, for example, by precipitations of solutions of silicates or flame hydrolysis of silicon halides with specific surface areas of 5-1000, preferably 20-400 m²/g (BET surface area) and primary particle sizes of 5-400 nm. The silicic acids can optionally also be present as mixed oxides with other metal oxides such as Al, Mg, Ca, Ba, Zn and Ti oxides, whereby silicic acids that are activated with suitable compounds such as for example Si 69® (Degussa) are preferably used.

synthetic silicates such as aluminum silicate, alkaline-earth silicate such as magnesium silicate or calcium silicate with BET surface areas of 20-400 m²/g and primary particle diameters of 5-400 nm.

natural silicates, such as kaolin and other naturally occurring silicic acids.

metal oxides, such as zinc oxide, calcium oxide, magnesium oxide, aluminum oxide.

metal carbonates, such as calcium carbonate, magnesium carbonate, zinc carbonate.

metal sulfates, such as calcium sulfate, barium sulfate.

metal hydroxides, such as aluminum hydroxide and magnesium hydroxide.

glass fibers and glass fiber products (laths, strands or glass microbeads).

thermoplastic fibers (polyamide, polyester, aramide).

rubber gels based on styrene-butadiene, polychloroprene, nitrile rubber, natural rubber, that have a high degree of crosslinking with particle sizes of 5-1000 nm and a glass transition temperature >−50° C.

polymeric fillers such as starch, cellulose, lignin, trans-1,4-polybutadiene, syndiotactic 1,2-polybutadiene etc.

The specified fillers can be used alone or in a mixture. In a particularly preferred embodiment of the method, 30-120 parts by weight of polybutadiene particles with a glass transition temperature <−60° C. (B), optionally together with 0.1-100 parts by weight of carbon black and/or 0.1-100 parts by weight of light-colored fillers, relative in each case to 100 parts by weight of un-crosslinked rubber (A), are used.

The rubber compounds according to the present invention can contain other rubber auxiliary substances, such as for example crosslinking agents, sulfur, reaction accelerators, antioxidants, heat stabilizers, light stabilizers, anti-ozonants, processing aids, plasticizers, tackifiers, blowing agents, dyes, pigments, waxes, resins, extenders, organic acids, retarders, metal oxides, and filler activators, such as for example triethanol amine, polyethylene glycol, hexane triol, bis(triethoxysilyl propyl) tetrasulfide or others known to the rubber industry.

The rubber auxiliary substances and fillers are used in conventional quantities, governed inter alia by the intended application. Conventional quantities are, for example, quantities of approx. 0.1 to 100, preferably 0.1 to 50 wt. %, relative to the amounts of rubber (A) used.

Sulfur, sulfur donors, peroxides or crosslinking agents, such as, for example, diisopropenyl benzene, divinyl benzene, divinyl ether, divinyl sulfone, diallyl phthalate, triallyl cyanurate, triallyl isocyanurate, 1,2-polybutadiene, N,N′-m-phenylene maleimide and/or triallyl trimellitate, can be used as conventional crosslinking agents. Other suitable examples include the acrylates and methacrylates of polyhydric, preferably dihydric to quadrihydric, C₂ to C₁₀ alcohols, such as ethylene glycol, propane diol-1,2-butane diol, hexane diol, polyethylene glycol with 2 to 20, preferably 2 to 8 oxyethylene units, neopentyl glycol, bisphenol A, glycerol, trimethyl propane, pentaerythritol, sorbitol with unsaturated polyesters consisting of aliphatic di- and polyols and maleic acid, fumaric acid and/or itaconic acid.

The rubber compounds according to the present invention can, furthermore, contain vulcanization accelerators. Examples of suitable vulcanization accelerators include, for example, mercaptobenzothiazoles, mercaptosulfenamides, guanidines, thiurams, dithiocarbamates, thioureas, thiocarbonates and dithiophosphates. The vulcanization accelerators, sulfur and sulfur donors or peroxides or further crosslinking agents such as for example dimeric 2,4-toluylidene diisocyanate (=Desmodur TT), 1,6-bis(N,N′-dibenzyl thiocarbamoyl dithio)hexane (preferred) or 1,4-bis-1-ethoxyhydroquinone (=crosslinking agent 30/10) are used in particular in quantities of 0.1-40 parts by weight, preferably 0.1-10 parts by weight, relative to the total quantity of rubber used.

Vulcanization of the rubber compounds according to the present invention can be performed at temperatures of 100-250° C., preferably 130-180° C., optionally under pressure of 10-200 bar.

The rubber compounds according to the present invention comprising a double bond-containing rubber (A) and additions of particles of polybutadiene rubber with a glass transition temperature of <−60° C. (B) can be produced in various ways:

First, it is obviously possible to mix the individual solid components. Suitable units for this process include rolls, internal mixers and also compounding extruders. In another manner, mixing by combining the latices of the un-crosslinked or alternatively, the crosslinked rubbers is also possible. The compound according to the present invention produced in this way can be isolated by conventional means, by evaporation, precipitation or by freeze coagulation (U.S. Pat. No. 2,187,146). The compounds according to the present invention can be obtained directly from the rubber/filler formulation by the incorporation of fillers into the latex mixture with subsequent recovery. Further mixing of the rubber mixture consisting of double bond-containing rubber (A) and rubber gel (B) with additional fillers and optionally rubber auxiliary substances can be performed in conventional mixing units, rolls, internal mixers and also compounding extruders. Preferred mixing temperatures are in the range 50-180° C.

The rubber mixtures according to the present invention are suitable, in particular, for the manufacture of tire components for which low heating-up under high dynamic stress is required, e.g., for bead compounds, tire carcasses, subtread compounds and tire sidewalls. The compounds are particularly suitable for the manufacture of reinforced sidewalls for tires with emergency running properties (inserts for run-flat tires).

The invention is further illustrated but is not intended to be limited by the following examples in which all parts and percentages are by weight unless otherwise specified.

### EXAMPLES

The BR rubber particles are produced according to U.S. Pat. No. 5,395,891, BR gel A1 and the SBR rubber particle according to EP 854 170 A1, example 1, by crosslinking the aqueous rubber dispersions by means of dicumyl peroxide. Characteristic data for the rubber particles is summarized in the table below:

| | Rubber | DOP | | Gel | | Glass | |
|---|---|---|---|---|---|---|---|
| Gel | type | quantity | Diameter | content | Swelling | trans. | Density |
| OBR | (BR/SBR) | (phr) | d50 [nm] | [%] | index | temp. [° C.] | [g/cm³] |
| 1052 A* | BR | 0.5 | 116 | 95 | 7.8 | −75 | 0.9191 |
| 1052 B* | BR | 1.0 | 116 | 97 | 7.4 | −66.5 | 0.9349 |
| 821 | BR | 1.0 | 123 | 97 | 5.4 | −60 | 0.9465 |
| 801 | BR | 1.0 | 157 | 98 | 4.7 | −55 | 0.9499 |
| 1049A | BR | 1.5 | 110 | 96 | 4.7 | −52 | 0.9556 |
| 802 | BR | 1.5 | 154 | 98 | 3.2 | −40.5 | 0.9668 |
| 803 | BR | 2.0 | 155 | 98 | 3.2 | −30.5 | 0.9764 |
| 900 | BR | 2.5 | 39 | 91 | 4.2 | −35 | 0.9864 |
| 901 | BR | 4 | 37 | 89 | 3.2 | −0.5 | 0.9965 |
| 786 | SBR | 1.5 | 56 | 98 | 4.9 | −22.5 | 0.9819 |

*according to the present invention

1c) Compound Production, Vulcanization and Results

The following compound series are produced and the properties of the corresponding vulcanizates determined:

Compound Series A:

In this compound series, it is demonstrated that the required objectives could not be achieved with rubber compounds that correspond to the prior art and do not contain the gels according to the present invention. The greatest shortfalls in the case of compounds containing carbon black (1-4) or activated silicic acid (5-8) occur in regard to Mooney scorch (MS), hysteresis losses (tan δ/60° C.) and heating-up under dynamic stress in the Goodrich flexometer test. In the case of compounds containing SBR gel (9-10), Mooney scorch, MS(130° C.), test (ΔT) and tan δ/60° C. are improved as compared with compounds 1-8. Shortfalls still exist in regard to impact resistances at 23° C. and 70° C. and to heating-up under dynamic stress in the Goodrich flexometer test and to tan δ/60° C.

| Compound no. | 1 | 2 | 3 | 4 | 5 | 6 | 7 | 8 | 9 | 10 |
|---|---|---|---|---|---|---|---|---|---|---|
| Natural rubber¹⁾ | 60 | 60 | 60 | 60 | 60 | 60 | 60 | 60 | | |
| SBR gel OBR | | | | | | | | | 120 | 120 |
| 786 (50 wt. % in | | | | | | | | | | |
| NR) | | | | | | | | | | |
| Buna ® CB 24²⁾ | 40 | | 40 | | 40 | | 40 | | | |
| Buna CB ® 65³⁾ | | 40 | | 40 | | 40 | | 40 | 40 | 40 |
| Carbon black N | 60 | 60 | 60 | 60 | 2 | 2 | 2 | 2 | 2 | 2 |
| 330 | | | | | | | | | | |
| Silica VN 3 | | | | | 60 | 60 | 60 | 60 | 20 | 20 |
| Si 69 ®⁴⁾ | | | | | 5 | 5 | 5 | 5 | 5 | 5 |
| Koresin⁵⁾ | 4 | 4 | 4 | 4 | 4 | 4 | 4 | 4 | 4 | 4 |
| Renopol L⁶⁾ | 5 | 5 | 5 | 5 | 5 | 5 | 5 | 5 | 5 | 5 |
| Zinc oxide | 5 | 5 | 5 | 5 | 5 | 5 | 5 | 5 | 5 | 5 |
| Stearic acid | 2 | 2 | 2 | 2 | 2 | 2 | 2 | 2 | 2 | 2 |
| TMQ⁷⁾ | 1.5 | 1.5 | 1.5 | 1.5 | 1.5 | 1.5 | 1.5 | 1.5 | 1.5 | 1.5 |
| 6PPD⁸⁾ | 2.5 | 2.5 | 2.5 | 2.5 | 2.5 | 2.5 | 2.5 | 2.5 | 2.5 | 2.5 |
| Sulfur | 5 | 5 | 5 | 5 | 5 | 5 | 5 | 5 | 5 | 5 |
| CBS⁹⁾ | 2 | 2 | 2 | 2 | 2 | 2 | 2 | 2 | 2 | 2 |
| Vulkacit D¹⁰⁾ | | | | | 2 | 2 | 2 | 2 | 2 | 2 |
| KA 9188¹¹⁾ | | | 3 | 3 | | | 3 | 3 | | 3 |

¹⁾SMR 5 (Standard Malaysian Rubber)
²⁾neodymium polybutadiene from Bayer AG
³⁾branched polybutadiene rubber from Bayer AG
⁴⁾bis(triethoxysilyl propyl disulfane) (Si 69 ® from Degussa AG)
⁵⁾condensation product consisting of t-butyl phenol and acetylene
⁶⁾mineral oil-based plasticizer
⁷⁾2,2,4-trimethyl-1,2-dihydroquinoline (Vulkanox ® HS from Bayer AG)
⁸⁾N-1,3-dimethylbutyl-N′-phenyl-p-phenylene diamine (Vulkanox ® 4020 NA from Bayer AG)
⁹⁾N-cyclohexyl-2-benzothiazyl sulfenamide (Vulkacit ® CZ from Bayer AG)
¹⁰⁾diphenyl guanidine from Bayer AG (Vulkacit ® D) 11) = trial product KA 9188 from Bayer AG (Vulcuren ®)

Reference is made to the following measured quantities in order to characterize the properties of the un-crosslinked compound:

Mooney viscosity ML 1+4 (100° C.); Mooney relaxation MR 30; Mooney scorch at 130° C.; and the tack is determined.

| Compound no.: | 1 | 2 | 3 | 4 | 5 | 6 | 7 | 8 | 9 | 10 |
|---|---|---|---|---|---|---|---|---|---|---|
| ML 1 + 4 (100° C.) | 79 | 75.3 | 48.4 | 44.7 | 78.6 | 71.3 | 48.5 | 46.2 | 55 | 51 |
| [ME] | | | | | | | | | | |
| MR 30 [%] | 13.4 | 14.3 | 8.1 | 7.6 | 10.0 | 10.0 | 6.4 | 6.1 | 10.9 | 9.1 |
| MS (130° C.) | 8.7 | 9.1 | 11.3 | 11.2 | 7.4 | 8.3 | 9.0 | 9.1 | 23.2 | 22.2 |
| Tack | 2.0 | 1.3 | 2.0 | 2.0 | 2.0 | 2.0 | 2.8 | 3.0 | 2.8 | 3.7 |

In the extrusion experiment (Garvey die extrusion) the extrusion rate and die swell are determined:

| Compound | | | | | | | | | | |
|---|---|---|---|---|---|---|---|---|---|---|
| no.: | 1 | 2 | 3 | 4 | 5 | 6 | 7 | 8 | 9 | 10 |
| Extrusion | 1.2 | 2.2 | | | 1.3 | 1.7 | | | 1.6 | 1.8 |
| rate [m/min] | | | | | | | | | | |
| Die swell | 47 | 50.0 | | | 47.8 | 37.9 | | | 26.1 | 23.2 |
| [%] | | | | | | | | | | |

| Compound no.: | 1 | 2 | 3 | 4 | 5 | 6 | 7 | 8 | 9 | 10 |
|---|---|---|---|---|---|---|---|---|---|---|
| Tensile strength | 16.7 | 17.4 | 14.1 | 12.7 | 13.8 | 12.9 | 9.7 | 9.4 | 11.5 | 5.0 |
| [MPa] | | | | | | | | | | |
| Elongation at | 215 | 220 | 120 | 115 | 215 | 190 | 103 | 90 | 260 | 75 |
| break [%] | | | | | | | | | | |
| Modulus at 50% | 2.5 | 2.6 | 4.3 | 4.3 | 2.3 | 2.5 | 4.2 | 4.5 | 2.2 | 3.7 |
| (MPa) | | | | | | | | | | |
| Modulus at 100% | 5.5 | 5.8 | 10.9 | 10.7 | 6.2 | 6.8 | 9.4 | — | 3.6 | — |
| (MPa) | | | | | | | | | | |
| Modulus at 300% | | | — | — | | | — | — | 7.8 | — |
| (MPa) | | | | | | | | | | |
| Shore A | 75 | 71 | 80 | 81 | 84 | 84 | 83 | 84 | 72 | 79 |
| hardness, 23° C. | | | | | | | | | | |
| Shore A | 74 | 74 | 79 | 79 | 82 | 83 | 82 | 83 | 67 | 75 |
| hardness, 70° C. | | | | | | | | | | |
| Impact resistance, | 50 | 48 | 57 | 52 | 54 | 52 | 59 | 58 | 39 | 43 |
| 23° C. [%] | | | | | | | | | | |
| Impact resistance, | 64 | 60 | 67 | 64 | 63 | 62 | 69 | 69 | 65 | 72 |
| 70° C. [%] | | | | | | | | | | |
| Goodrich | 22.6 | 20.4 | 20.0 | 21.9 | 19.2 | 21.1 | 17.7 | 20.0 | 9.4 | 7.9 |
| flexometer ΔT [° C.] | | | | | | | | | | |
| Goodrich | 141.4 | 141.8 | 136.6 | 139.0 | 136.7 | 137.8 | 132.8 | 133.5 | 123.1 | 117.4 |
| flexometer T [° C.] | | | | | | | | | | |
| tan δ (60° C.) | 0.094 | 0.106 | 0.096 | 0.101 | 0.114 | 0.123 | 0.104 | 0.106 | 0.069 | 0.049 |

On the basis of the above compounds, the following test results are obtained after 15 minutes of vulcanization time at 165° C.

Compound Series B:

In this compound series, it is demonstrated that the rubber compounds according to the present invention display advantages with respect to the required properties. It can be seen, in particular, that compounds containing rubber particles having glass transition temperatures <−60° C. exhibit unexpectedly favorable properties in terms of hysteresis losses (tan δ/60° C.) and of -heating-up in the Goodrich flexometer test (ΔT).

In a laboratory internal mixer various different compounds (quoted in phr) are produced on the basis of various BR gels according to the formulation below. The compound components are mixed in the sequence indicated in the table:

| Compound no.: | 1* | 2 | 3 | 4* | 5 | 6 | 7 | 8 |
|---|---|---|---|---|---|---|---|---|
| Natural rubber, | 60 | 60 | 60 | 60 | 60 | 60 | 60 | 60 |
| premasticated | | | | | | | | |
| OBR 1052 A/0.5 DCP | 60 | | | | | | | |
| OBR 801/1.0 DCP | | 60 | | | | | | |
| OBR 821/1.0 DCP | | | 60 | | | | | |
| OBR 1052 B/1.0 DCP | | | | 60 | | | | |
| OBR 802/1.5 DCP | | | | | 60 | | | |
| OBR 803/2.0 DCP | | | | | | 60 | | |
| OBR 900/2.5 DCP | | | | | | | 60 | |
| OBR 901/4 DCP | | | | | | | | 60 |
| Buna CB 65 | 40 | 40 | 40 | 40 | 40 | 40 | 40 | 40 |
| Carbon black N 330 | 2 | 2 | 2 | 2 | 2 | 2 | 2 | 2 |
| Silica VN 3 | 20 | 20 | 20 | 20 | 20 | 20 | 20 | 20 |
| Si 69 ® | 5 | 5 | 5 | 5 | 5 | 5 | 5 | 5 |
| Koresin | 4 | 4 | 4 | 4 | 4 | 4 | 4 | 4 |
| Renopol L | 5 | 5 | 5 | 5 | 5 | 5 | 5 | 5 |
| Zinc oxide | 5 | 5 | 5 | 5 | 5 | 5 | 5 | 5 |
| Stearic acid | 2 | 2 | 2 | 2 | 2 | 2 | 2 | 2 |
| TMQ | 1.5 | 1.5 | 1.5 | 1.5 | 1.5 | 1.5 | 1.5 | 1.5 |
| 6PPD | 2.5 | 2.5 | 2.5 | 2.5 | 2.5 | 2.5 | 2.5 | 2.5 |
| Sulfur | 5 | 5 | 5 | 5 | 5 | 5 | 5 | 5 |
| CBS | 2 | 2 | 2 | 2 | 2 | 2 | 2 | 2 |
| KA 9188 | 3 | 3 | 3 | 3 | 3 | 3 | 3 | 3 |

*according to the present invention

| Compound no.: | 1* | 2 | 3 | 4* | 5 | 6 | 7 | 8 |
|---|---|---|---|---|---|---|---|---|
| ML 1 + 4 (100° C.) [ME] | 50.8 | 58.5 | 46 | 50.9 | 46.9 | 45.6 | 38.1 | 41.5 |
| MR 30 [%] | 8.5 | 11.8 | 6.3 | 8.6 | 6.8 | 6.1 | 5.2 | 5.8 |
| MS (130° C.) | 22.8 | 20.1 | 21.9 | 22.2 | 20.9 | 19.8 | 23.1 | 23.8 |
| Tack | 2.5 | 3.0 | 4.2 | 3.0 | 3.5 | 4.0 | 4.3 | 3.3 |
| Compound no.: | 1 | 2 | 3 | | 4 | 5 | 6 | 7 |
| Extrusion rate [m/min] | | 1.9 | 2.0 | | 2.1 | 2.1 | 2.2 | 2.3 |
| Die swell [%] | | 20.7 | 18.6 | | 19.4 | 20.3 | 19.4 | 17.6 |

*according to the present invention

On the basis of the above-compounds, the following test results are obtained after 15 minutes of vulcanization time at165° C.:

| Compound no.: | 1* | 2 | 3 | 4* | 5 | 6 | 7 | 8 |
|---|---|---|---|---|---|---|---|---|
| Tensile | 2.0 | 3.8 | 4.0 | 2.5 | 7.1 | 9.7 | 7.3 | 8.1 |
| strength [MPa] | | | | | | | | |
| Elongation at | 65 | 65 | 80 | 60 | 85 | 120 | 150 | 185 |
| break [%] | | | | | | | | |
| Modulus at | 4.6 | 2.8 | 2.4 | 2.1 | 4.0 | 3.9 | 2.8 | 3.0 |
| 50% (MPa) | | | | | | | | |
| Modulus at | | — | — | | — | 7.8 | 4.9 | 4.6 |
| 100% (MPa) | | | | | | | | |
| Modulus at | | — | — | | — | — | — | — |
| 300% (MPa) | | | | | | | | |
| Shore A | 65 | 75 | 72 | 70 | 81 | 81 | 75 | 78 |
| hardness, | | | | | | | | |
| 23° C. | | | | | | | | |
| Shore A | 67 | 75 | 72 | 71 | 79 | 79 | 72 | 72 |
| hardness, | | | | | | | | |
| 70° C. | | | | | | | | |
| Impact | 78 | 58 | 60 | 72 | 51 | 47 | 38 | 34 |
| resistance, | | | | | | | | |
| 23° C. [%] | | | | | | | | |
| Impact | 84 | 77 | 77 | 82 | 69 | 64 | 63 | 52 |
| resistance, | | | | | | | | |
| 70° C. | | | | | | | | |
| Goodrich | 0.4 | 9.8 | 8.7 | 2.3 | 12.1 | 12.8 | 13.9 | 18.1 |
| flexometer ΔT | | | | | | | | |
| [° C.] | | | | | | | | |
| Goodrich | 102.4 | 109.7 | 106.5 | 103.8 | 118.3 | 121.4 | 124.1 | 138.1 |
| flexometer T | | | | | | | | |
| [° C.] | | | | | | | | |
| tan δ (60° C.) | 0.011 | 0.028 | 0.018 | 0.014 | 0.057 | 0.085 | 0.086 | 0.155 |

*according to the present invention

As the tests show, the objects set according to the present invention (particularly the low hysteresis losses and low heating-up under dynamic stress) are met only when rubber particles based on polybutadiene are used (see also comparison in compound series A with particles based on SBR) and when their glass transition temperature displays values of <−60° C.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Rubber compounds comprising at least one double bond-containing rubber (A) and particles of polybutadiene rubber with a glass transition temperature of <−60° C. (B), whereby component (B) is present in quantities of 10 to 150 wt. %, relative to the total quantity of component (A), and optionally other fillers and rubber auxiliary substances in conventional quantities.

2. Rubber compounds according to claim 1, wherein component (B) is present in quantities of 30 to 120 wt. %.

3. Rubber compounds according to claim 1, wherein said double bond containing rubbers (A) is selected from the group consisting of NR, BR, SBR, SIBR and SNBR.

4. Rubber compounds according to claim 1, wherein said rubber auxiliary substance is 1,6-bis(N,N′-dibenzyl thiocarbamoyl dithio)hexane.

5. Rubber compounds according to claim 1, wherein said additional filler is silicic acid.

6. Rubber compounds according to claim 1, wherein said additional filler is silicic acid activated with Si 69®.

7. Rubber compounds according to claim 1, wherein the particles of polybutadiene rubbers exhibit a glass transition temperature in the range from −65° C. to −100° C.

8. Tire components comprising at least one double bond-containing rubber (A) and particles of polybutadiene rubber with a glass transition temperature of <−60° C. (B), whereby component (B) is present in quantities of 10 to 150 wt. %, relative to the total quantity of component (A), and optionally other fillers and rubber auxiliary substances in conventional quantities.

9. Tire components according to claim 8, wherein said tire component is a tire bead and apex compound, subtread compounds, tire carcasses and tire side walls.

10. Tire components according to claim 8, wherein component (B) is present in quantities of 30 to 120 wt. %.

11. Tire components according to claim 8, wherein said double bond containing rubbers (A) is selected from the group consisting of NR, BR, SBR, SIBR and SNBR.

12. Tire components according to claim 8, wherein said rubber auxiliary substance is 1,6-bis(N,N′-dibenzyl thiocarbamoyl dithio)hexane.

13. Tire components according to claim 8, wherein said additional filler is silicic acid.

14. Tire components according to claim 8, wherein said additional filler is silicic acid activated with Si 69®.

15. Tire components according to claim 8, wherein the particles of polybutadiene rubbers exhibit a glass transition temperature in the range from −65° C. to −100° C.

16. Tire components according to claim 8 wherein said tire component comprises tire sidewall inserts for tires with emergency running properties.
